(19) United States
(12) Patent Application Publication
(10) Pub. No.: US 2002/0116313 A1
(43) Pub. Date: Aug. 22, 2002

(54) Method of auctioning advertising opportunities of uncertain availability

(76) Inventor: Dietmar Detering, Halle (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 09/737,018

(22) Filed: Dec. 14, 2000

(51) Int. Cl. G06F 17/60

(52) U.S. Cl. 705/37; 705/14

(57) ABSTRACT

A method of quickly and efficiently determining pricing and allocation of advertising messages in a diversity of documents to be presented to a diversity of users with varying degrees of targeting information known about them. A database of individual users' profiles is maintained. Profiles may contain information about users' demographics, interests, and behavior patterns. Advertisers place bids on reaching users. Bids are collected and stored until a user requests a document that can be combined with an advertising message to be presented to user. Then, different bids of reaching that user are compared to determine the winning bid, serve the advertising message, and to determine the price to be paid by the winning advertiser. Means are provided to make bids react dynamically on the content of the requested documents and on the overall schedule of reaching users repeatedly, to discount bids if advertising message is likely to be undesirable, and to allocate advertising messages into documents provided by third parties.

### CROSSREFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The following invention relates to auction methods and methods of auction automation. The present invention enables potential buyers of large numbers of diverse goods of uncertain availability to specify and select desired items and to purchase them individually through an automated auction process each time one item becomes available. The method also relates to methods of matchmaking, pricing optimization, and rationalized decision-making under conditions of uncertain and confusingly diverse information.

### PRIOR ART

Auctions are a way to determine the optimal price for a good and to allocate it to the most efficient use, in particular, if the good is unique and/or if there is no continuous market activity determining an optimal price that would ensure allocation efficiency and supply and demand equilibrium. Also, auctions helps potential buyers to gauge their willingness to pay against other potential buyers, thereby offering them hints about whether their own valuation of an offered good is realistic. Useful applications of auctions can be seen in:

Arts: Offered goods are unique, there is no market activity to determine a price bringing the market into equilibrium, and buyers are uncertain of the potential value of the items.

Electromagnetic spectrum for telecommunication: Offered goods are homogeneous, but there has been no market history and potential buyers are uncertain of the future value of the goods.

Stock/bonds: There is a market history, but the circumstances that determine the expectations of the future value of the offered titles change frequently. Therefore, the uncertainty remains.

While most auction schemes require the bidder's ongoing attention until the winning bid is determined, in computer networks there are some processes of automating auctions. One example is offered by auction Web sites such as eBay (here called “proxy bidding”), where bidders can place maximum bids on offered items. Each competing bid will be automatically outbid by a required increment until either the maximum bid of the bidder is reached or competing bidders are placing no new bid until the end of the auction. However, bidders still have to place bids manually on particular, currently offered items.

Internet advertising service Almondnet (www.almondnet.com) offers a new auction scheme (“Pro-Market”) where bids are automatically being generated and placed on advertising opportunities in the very moment of their occurrence. Immediately, the computer determines the winning bid and places a corresponding advertising message in a requested document. Bidding advertisers prepare their campaign and their bidding rules by specifying bids on individual criteria of their target audience and the duration of their campaign. For example, they can say that they want to reach their audience in the month of October 2000 and bidding 5 cents for each female, 10 cents for each user being between 21 and 34 years old, and 7 cents for the appearance of their message with political news content. Advertisers can also specify mandatory conditions, such as that the recipient must be from the New York City Metropolitan Area. Given that it is October 2000 and a 28 year-old woman is requesting a document with political news from a participating Web site (that knows all this information), the advertiser's bid is being calculated (22 cents) and compared with other bids. The advertising message associated with the winning bid will than be placed into the requested document and a fee of 22 cents will be charged to the advertiser. Correspondingly, if a 31 year-old man requests a document containing a movie review from a participating site, here, the advertiser's bid would be only 10 cents.

### BRIEF SUMMARY OF THE INVENTION

Almondnet's Pro-Market faces at least two problems. First, Almondnet can only control how often advertisers reach the same user by placing identifiers (cookies) on the user's hard drive. Second, it can hardly react upon variant and more complicated conditions of a campaign, such as “don't expose this message to the same user more than once a day and decrease my bids by 10% each time I am going to reach a same user again”, as this would require a lot of computation power and data storage.

It is the objective of this invention to offer an auction scheme that is as flexible as Almondnet's Pro-Market in immediately reacting upon new opportunities and generating efficient prices, meanwhile equipped with the new functionality to differentiate between recurrent and first-time users. Also, the number of computing operations required for each advertising message at the very moment of its occurrence will be minimized, thus increasing the reaction speed of the system. By using an approach of bidding and the organization of bids around profiles of individuals and not around abstract profiling criteria, most computing operations of this invention are completed before an advertising opportunity occurs. In AlmondNet's approach, however, each single competing bit has to be calculated after an advertising opportunity occurs.

Advertisers specify their audience preferences (interests, demographics, provided content). As a result, a ranking list of potential contacts will be drawn from a database of profiled individuals and displayed to the advertisers, who then express their maximum bid for contacting each one of the displayed contacts. They can also specify additional criteria for their campaign, such as a deadline when all remaining bids are revoked. The auction process itself takes place automatically: Each time a user can get exposed to an advertising message, the message of the bidder with the highest bid for contacting this member wins. The price to be paid by the winning bidder can be determined in accordance with a number of auction schemes. For example, in a Vickrey-type auction scheme the price that the advertiser pays is equal to the highest losing bid for that user. As a result, advertisers would always pay less than their—under this scheme actually fully revealed—willingness to pay.

One potential application of this invention would be Internet services that have profiles of regularly contacted users, in particular, if the profiling information is of diverse degrees of comprehensiveness. In another application, other Internet services can contact an agent that stores profiling information of users. If a user can be identified, for example through a cookie of the agent being stored on that user's computer at an earlier occasion, the agent can place advertising messages in the document provided by the other site after performing the advertising auction process. Also, as different Internet services have diverse information about their users, this can be combined to a more comprehensive, centralized profile of users while anonymity could still be ensured.

### BRIEF DESCRIPTION OF THE DRAWINGS

These steps and their underlying mechanisms, as well as other objects and advantages of this invention, will be more completely understood and appreciated by the study of a detailed description of the invention, viewed in conjunction with the accompanying drawings, of which:

FIG. 1 is a block diagram illustrating the overall environment in which the present invention may be used.

FIG. 2 is a flow chart depicting the steps of an advertiser placing bids on reaching individual users with an advertising message.

FIG. 3 is a flow chart illustrating the steps leading to the selection and placement of a particular advertising message into a document being presented to a user.

FIG. 4 is a flow chart showing means to place advertising messages into documents provided by other parties in accordance with the present invention.

### DETAILED DESCRIPTION OF THE INVENTION

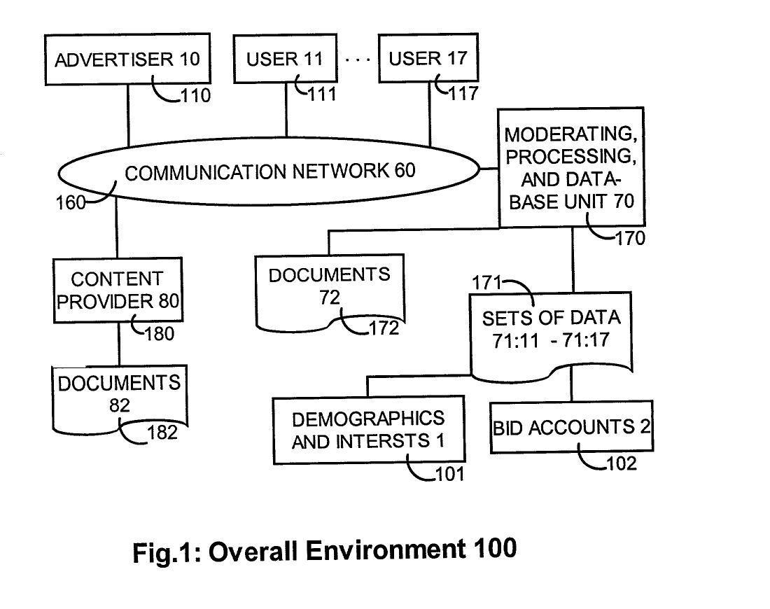

The block diagram of FIG. 1 shows an example of an overall environment 100 in which the present invention may be used. This environment includes a communication network 60 (box 160) that is able to transport messages exchanged between the entities and individuals connected to it. Thus, network 60 may be fully represented by the Internet or any other form of communication system. Each box 111-117 represents a participating user 11-17 connected to network 60. Box 110 represents at least one advertiser 10 who is connected to network 60. Also, a moderating, filtering processing and database unit 70 (box 170), which may be a computer system or a human operator, is connected to network 60. Box 180 represents at least one other content provider 80 who also can be connected to network 60. Content provider 80 offers at least one document to users 11-17 out of his documents database 82, represented by box 182. Thus, data can be exchanged between each user, advertiser, content provider, and unit 70 over network 60. Documents (as well as the advertising messages to be placed therein) can be of any kind or form of media, such as text, pictures, audio and/or video.

A line from box 170 to box 171 shows that unit 70 stores the data 71 of each user (71:11-71:17). Each individual set of data contains at least two subsets of data: the users' demographics and interests 1 (box 101) and users' bid accounts 2 (box 102). Subset 1 of data may contain but is not limited to the age, size, weight, educational background, professional background, traits, interests, social circles, values, etc. A line to box 172 shows that unit 70 can also store documents in a documents database 72, from which documents can be offered to users 11-17 over network 60. Information stored in unit 70 can also be stored on other computers that are connected to the network, including those of users, other content providers, and advertisers.

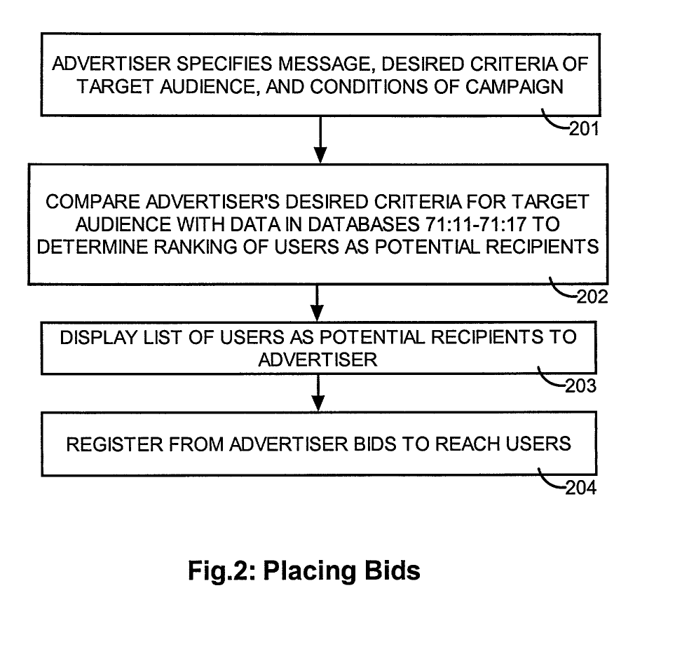

The flowchart of FIG. 2 shows the steps of an advertiser placing bids for reaching individual users with an advertising message. Initially, the advertiser specifies the advertising message, his criteria of the desired target audience, and additional conditions of the campaign (step 201). He does so through communication over network 60 with unit 70, wherein such communication links could be secured by a login name and password, and technical access and communication could be provided, for example, through the advertiser's computer connected to unit 70 over the Internet and using an Internet Browser program, such as Microsoft Internet Explorer, Version 5.5, or Netscape Communicator, Version 6.0. Specified criteria of the desired target audience might include but are not limited to demographic values (age, gender, ZIP code, profession, etc.) and fields of interest (national baseball, ancient arts, etc.). Conditions of the campaign may include but are not limited to the duration of the campaign and maximum expenditure. Also, an advertiser can specify preferences for certain content to be requested by users and presented together with the message, for example, news about airplane crashes. The advertiser may provide this information through standardized terms in a form resembling information stored in database 71, which, in turn, has been actively and voluntarily provided by the user or which might have been generated by observing the user's behavior or been collected from other sources where such data is already available.

In step 202, unit 70 compares the advertiser's specified criteria of his target audience with the user information 1 that is stored in databases 71:11-71:17. The following table offers an example of how this could be accomplished:

TABLE 1

| | Advertiser's | | | Max. |
|---|---|---|---|---|
| | Preferences | User 11 | Value | Value |
| Interests | 4 Points: Includes | Cooking, | 4 | 4 |
| | Tennis | Baseball, | | |
| | | Tennis, . . . | | |
| Gender | 2 Points: Female | N/A | — | 2 |
| Age | Must: min. 21 | 32 | o.k. | — |
| Family | 4 Points: Has Children | Yes | 4 | 4 |
| Position at | 8 Points: Management | Manage- | 8 | 8 |
| Work | | ment | | |
| Annual Income | 4 Points: >$100,000 | $65,000 | — | 4 |
| Total | | | 8 | 22 |

The degree of how closely user 11 matches the preferences of the coordinator can be measured in points that are calculated according to an index value of 100, representing the maximum. In this example, user 11 earns no points for Income because his is less than $100,000 and he receives no points for his gender because this information is not available in the profile (in the latter case, he might receive one point according to an alternative calculation rule—reflecting the chances that user 11 is female). After comparing all the preference criteria of the coordinator, user 11 received 8 points out of 22 possible points, signifying 36.4 of the index (100). After calculating this value for all relevant users, a ranking list of potential recipients can be displayed to the advertiser in step 203. This list can assist him determining his optimum bidding structure and level to successfully and efficiently conduct his campaign. Step 203 can also include displaying average prices of reaching those users in the past as a guideline for the advertiser. Step 204 then records the bids for reaching that audience on an individual basis and updates the bid accounts 2 in database 71 accordingly, wherein the advertiser can also specify rules for automated determination of his bids. For example, such a rule could be written as follows:

“Maximum bid per potential recipient is $1 for a user who reached 100 points on tie index. A discount shall be applied according to the number of indexed points that each user has reached, so that, for example, I will hereby place a maximum bid of 36 cents on a user with 36 points. Each time that I reach a user another time, my maximum bids for that user shall be reduced by 20%, and I want to have a period of at least 24 hours between each contact.”

Unit 70 can also compute the corresponding bids and determine a reasonable expectation on that campaign's success and costs based on past experiences with reaching those users and the other bids that are competing for the users' attention. As a further refinement, advertisers could condition their bids in regard to the type of content being requested by a user and being presented to him. Also, unit 70 could compute a discount to each bid if the advertising content seems to be likely to be undesired by the majority of users. While this bid discounting reduces the likelihood of the bids to outbid other bids, the advertiser still would pay an undiscounted price per contact:

For example, if an advertiser bids $1 for one user and the system would discount that bid by 50%, this bid would only outbid those bids that are at least as small as 50 cents. Assume that the highest losing bid (in a Vickrey-type auction scheme) is 30 cents; the advertiser would outbid this bid but pay 60 cents to reflect the discounted value of his bid. Alternatively, advertisers with undesired messages could be required to pay a premium surcharge of 100% on their prices, which would make them reduce their bids themselves. On the other hand, advertisers with particularly desirable messages could receive preferential treatment through a corresponding treatment.

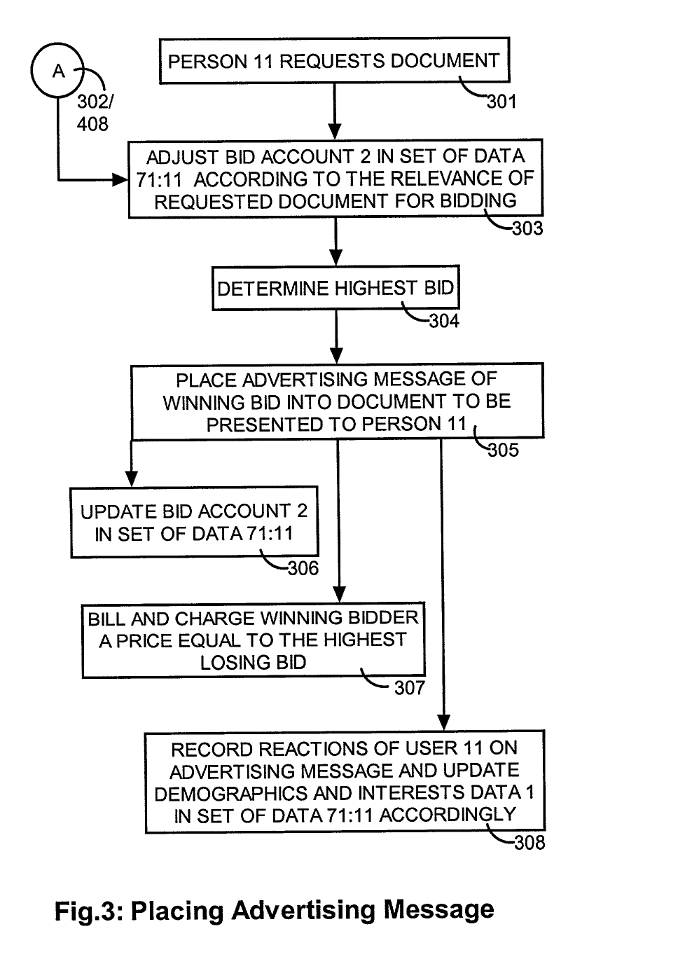

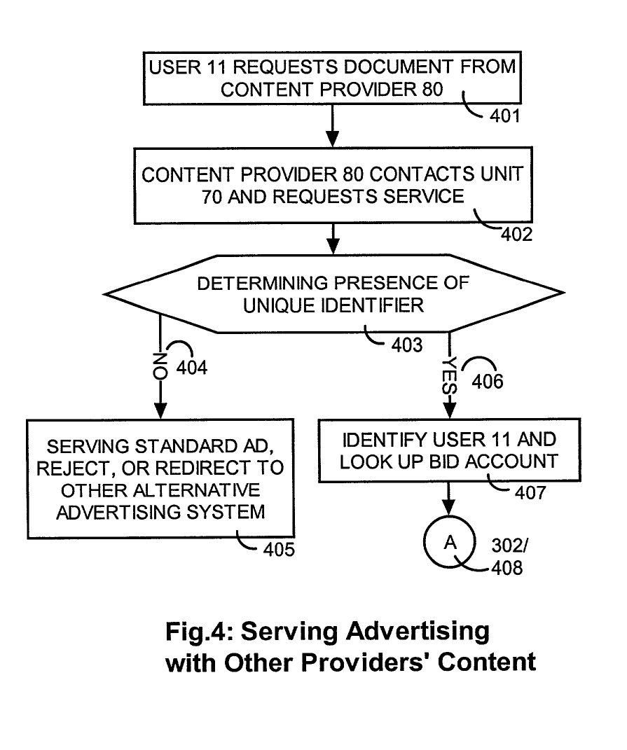

The flowchart of FIG. 3 illustrates, in detail, the steps leading to the selection and placement of a particular advertising message into a document being presented to a user. In step 301, user 11 requests a document from unit 71. Step 302/408 shows that step 301 can also be replaced through a process explained in FIG. 4, which leads through connector A to step 303 just as step 301 does. Step 303 determines whether the requested document's content is of any particular relevance to the bids in the bid account 2 of set of data 71:11 and temporarily adjusts the bids accordingly. Subsequently, the highest bid is determined in step 304, and step 305 places the advertising message of the winning bid into the document to be presented to user 11. From this, three independent steps follow as a result of the successful bid: (1) Step 306 updates the bid account 2 in set of data 71:11, for example, changing the value or deleting altogether the bid that has won. (2) Step 307 ensures that the winning bidder will be charged an amount corresponding to the applied auction rules (in this case, the winning bidder pays a price equal to the highest losing bid). (3) Step 308 records observable reactions of user 11 on the advertising message and updates the demographics and interests subset of data 1 in set of data 71:11 accordingly.

The flowchart of FIG. 4 shows how advertising messages can be placed into documents provided by other parties in accordance with the present invention. In step 401, user 11 requests a document from content provider 80, who in turn contacts unit 70 through communication network 60 to request service (step 402). In the following step 403, unit 70 determines the presence of a unique identifier on the computer of user 11, for example, a cookie placed by unit 70 on the user's computer earlier. Alternatively, content provider 80 could communicate identifying information to unit 70. If no unique identifier can be found (decision arrow 404), unit 70 serves a standard advertising message, rejects the service altogether, or redirects the advertising opportunity to an alternative advertising service in step 405. However, if a unique identifier can be found (decision arrow 406), step 407 identifies user 11 and looks up bid account 2 in set of data 71:1 1.

While the invention has been described in connection with what is presently considered to be the most practical and preferred embodiment, it should be considered that the invention is susceptible to modification, variation and change without departing from the proper scope and fair meaning of the accompanying claims. Of necessity, the steps in the claims are listed in particular order, though it should be noted that a different order of certain steps in the claims would yield logically equivalent results, which are equivalently claimed and are not disclaimed.

I claim:

1. A method of selling advertising opportunities, said method comprising the steps of:
a) arranging a database of profiling information about users relating to their demographics, interests, and/or behavior patterns;
b) offering to advertisers the opportunity to reach desired types of users from that data-base, each advertiser specifying the advertising message, his preferences for the number and desired criteria of users to be reached, and other conditions of the desired campaign;
c) determining a choice of users who sufficiently match the criteria as specified by the advertiser and presenting at least a selection or a summary of data about said choice of users to said advertiser, said data also being able to indicate the degree to which a member of said choice matches the advertiser's preferences;
d) eliciting and recording, from the advertiser, price bids of what he is willing to pay to reach each member of said choice with his message;
e) aggregating and storing currently competing bids of all participating advertisers to reach a same user with an advertising message in that user's bid account;
f) determining the advertising message with the highest bid each time that a corresponding user can be presented with an advertising message;
g) exposing the winning advertising message to the user;
h) billing the winning advertiser the due fee as calculated according to the applied auction rules; and
i) updating the user's bid account according to the auction rules and the conditions of the campaign specified by the winning bidder.

2. A method defined in claim 1, further comprising the step of forwarding all or part of the advertising revenue to the users who are exposed to the corresponding advertising messages.

3. A method defined in claim 1, further comprising the step of placing a unique identifier on a user's computer, relating advertising opportunities of other parties to the recipient's known profiling information and bid account, and facilitating the other parties' participation in the auction process.

4. A method defined in claim 1, wherein the choice of users determined in accordance to the advertisers preferences reflects uncertain assumptions that are based on other criteria.

5. A method defined in claim 4, wherein the data indicating the degree to which a member of said choices matches the advertiser's preferences also reflects the uncertainty of said used information.

6. A method defined in claim 1, further enabling the advertiser to combine two or more campaigns in a way that, if bids of two or more such campaigns are being placed on the same user, such bids do not compete with each other and either the higher or the lower one competes with bids of other advertisers or non-combined campaigns.

7. A method defined in claim 1, wherein advertiser's bids can refer to criteria of the content being received by the users when receiving the advertising message, adjusting the bids competing in the automated bidding process accordingly.

8. A method defined in claim 1, further comprising the step of setting a minimum price to be paid for reaching users in the database.

9. A method defined in claim 1, further comprising the step of discriminating against different types of advertising messages by manipulating the relative weight of a corresponding bid in the bidding process and/or by charging for certain categories of messages a price that deviates from the price determined in the auction process.

10. A method defined in claim 1, further comprising the step of the advertiser specifying differentiated bids or a rule to derive differentiated bids to reach a same user repeatedly during the time of the campaign.

11. A method defined in claim 1, wherein the advertising message contains at least one unique identifier specifying the message, the user, or both.

12. A method defined in claim 1, further comprising the step of recording the exposure of a user to a message of an advertiser and of preventing that user from being repeatedly exposed to a similar message of the same advertiser in a future campaign.

13. A method defined in claim 12, further comprising the step of preventing a user from being repeatedly exposed to a similar message of the same advertiser, to which he had previously responded, as indicated by response data.

14. A method defined in claim 1, further comprising the step of recording the exposure of a user to a message of an advertiser and of automatically discounting the advertiser's bid for future exposures of that user to the same or another specified advertising message.
